(19) United States
(12) Patent Application Publication
(10) Pub. No.: US 2014/0275629 A1
(43) Pub. Date: Sep. 18, 2014

(54) Method and Apparatus for the Electrical Activation of a Catalyst

(71) Applicants: Ed Ite Chen, New York, NY (US); Tara Cronin, New York, NY (US)

(72) Inventors: Ed Ite Chen, New York, NY (US); Tara Cronin, New York, NY (US)

(21) Appl. No.: 14/209,397

(22) Filed: Mar. 13, 2014

Related U.S. Application Data
(60) Provisional application No. 61/782,086, filed on Mar. 14, 2013.

(51) Int. Cl. B01J 19/08

(52) U.S. Cl. CPC B01J 19/088
USPC 568/300; 422/186.04; 422/148; 204/177

(57) ABSTRACT

A reaction chamber includes: a catalyst that, in use, is wired to a power source in electrical short circuit configuration with a current limiting circuit in the power supply; and a reaction volume in which the catalyst is disposed and wherein reactants are introduced while a current is introduced across the short circuited catalyst. The reaction chamber may also be a part of system that includes the reactant feedstocks and a power supply. In operation, a plurality of reactant feedstocks are provided to a reaction volume within the reactor. The catalyst electrically activated through the short circuit to reacting the reactant feedstocks in the presence of the electrically activated catalyst. The yield product of the reactions is then collected.

### CROSS-REFERENCE TO RELATED APPLICATIONS

The priority of U.S. Provisional Application Ser. No. 61/782,086, entitled, “Method for the Electrical Activation of Catalyst at Low Temperatures and Pressures”, filed Mar. 14, 2013, in the name of the inventor Ed Ite Chen is hereby claimed for all common subject matter under 35 U.S.C. §119(e).

### STATEMENT REGARDING FEDERALLY SPONSORED RESEARCH OR DEVELOPMENT

Not applicable.

### BACKGROUND

This section introduces information from the art that may be related to or provide context for some aspects of the technique described herein and/or claimed below. This information is background facilitating a better understanding of that which is disclosed herein. This is a discussion of “related” art. That such art is related in no way implies that it is also “prior” art. The related art may or may not be prior art. The discussion is to be read in this light, and not as admissions of prior art.

Solid catalyst activation typically requires energy to be applied, either through chemical, electrochemical means, or the application of heat and pressure. This is required because reactions need thermodynamic energy to occur. However, because electrons are the primary carriers of chemical reaction and chemical bonding energy, electrochemical reactions may occur at much lower temperatures than heat and pressure as a means to activate solid catalysts. Yet the narrow range of temperatures in which aqueous reactions may occur, and the high energies required for other forms of electrochemical reactions to occur, as well as the relatively low rates displayed by electrochemical activation of catalyst has limited the usefulness of this means of catalyst activation. Furthermore, the need for an anode and a cathode has led to problems in maintaining the efficiency of the catalysts on the electrodes, as corrosion, deactivation, and sensitivity to electrolyte is a major problem.

Accordingly, there are several techniques for solid catalyst activation available to the art, all of which are competent for their intended purposes. The art however is always receptive to improvements or alternative means, methods and configurations. Therefore the art will well receive the catalyst activation technique described herein.

### SUMMARY

In a first aspect, a reaction chamber comprises: a catalyst that, in use, is wired to a power source in electrical short circuit configuration with a current limiting circuit in the power supply; and a reaction volume in which the catalyst is disposed and wherein reactants are introduced while a current is introduced across the short circuited catalyst.

In a second aspect, a system comprises: a plurality of reactant feedstocks; a power supply; and a reactor. The reactor, in turn, comprises: a catalyst that, in use, is wired to the power source in electrical short circuit configuration; a reaction volume in which the catalyst is disposed and wherein the reactant feedstocks are introduced while a current is introduced across the short circuited catalyst to react the reactant feedstocks and yield a product; and a collector for the product yielded by the reaction.

In a third aspect, a method comprises: providing a plurality of reactant feedstocks to a reaction volume within a reactor; electrically activating a short-circuited catalyst disposed within the reaction volume of the reactor; reacting the reactant feedstocks in the presence of the electrically activated catalyst; and collecting the yield product of the reactions.

The above paragraph presents a simplified summary of the presently disclosed subject matter in order to provide a basic understanding of some aspects thereof. The summary is not an exhaustive overview, nor is it intended to identify key or critical elements to delineate the scope of the subject matter claimed below. Its sole purpose is to present some concepts in a simplified form as a prelude to the more detailed description set forth below.

### BRIEF DESCRIPTION OF THE DRAWINGS

The invention may be understood by reference to the following description taken in conjunction with the accompanying drawings, in which like reference numerals identify like elements, and in which:

FIG. 1 depicts one particular embodiment of a reactor in accordance with the currently disclosed technique.

FIG. 2 illustrates an exemplary embodiment in which the reactor of FIG. 1 may be used.

FIG. 3A-FIG. 3C are side, top, and bottom plan views, respectively, of the reactor of FIG. 1.

FIG. 4A-FIG. 4D are opposing side, top, and bottom plan views, respectively, of the accumulator first shown in FIG. 2.

FIG. 5A-FIG. 5D are opposing side, top, and bottom plan views, respectively, of the cold trap first shown in FIG. 2.

FIG. 6 is a schematic of one particular implementation of the system in FIG. 2.

FIG. 7 is schematic of an embodiment in which the presently disclosed technique is used to mitigate emissions and provide hybrid power to a vehicle.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

The technique disclosed herein utilizes catalysts for reaction of reactants at high rates and in ranges which are often atypical of operating temperatures, pressures, and voltages found in conventional solid catalyst activation. More particularly, the technique presents a process for the activation of a solid catalyst by the introduction of an electrical current for the reaction of gas-liquid-solid, liquid-liquid, gas-liquid, gas-gas reactions, gas-solid, liquid-solid, and solid-solid reactants as well as supercritical reactants and any combination of the aforementioned components. It moreover provides means to control the reaction dynamics of the activation through the control of the electrical characteristics of the electrical charge as described below. The catalyst itself is electrically conductive or may be provided an electrically conductive solid catalyst support.

The technique includes a reactor that comprises at least two components: a catalyst and a reaction vessel. The catalyst may, if conductive, be connected directly to a power supply, wired in an electrical short circuit along with a current overload circuit in the power supply. The catalyst may be mounted onto an electrically conductive catalyst support if the catalyst is not itself conductive. Supplying electrical current across the catalyst either directly or through a conductive support will then activate the solid catalyst. The conductive material is wired in a short circuit along with a current overload circuit in the power supply to a power supply. The reaction vessel brings reactants in contact with the electrically activated catalyst.

The catalyst may be formed in a variety of manners. For example, the catalyst may include a blend of different known catalysts. The catalyst may a catalyst drawn into a wire. The configuration of the solid catalyst is not limiting to this technique, although different configurations may enhance the rates further due to other known chemical and physicobonding effects that speed up rates.

Although the catalysts in the embodiments disclosed herein are solids, some embodiments may employ catalysts that are fluid. Because a part of the reactor disclosed herein may also charge fluids, a catalytic fluid would be possible. Such a fluid catalyst may be, for example, an organic porphyrin, or other organic carrier substance which might be considered a catalyst. It might also simply be a dissolved metal salt. Other fluid catalysts may become apparent to those skilled in the art having the benefit of this disclosure.

Not all suitable solid catalysts and not all catalyst supports will necessarily be electrically conductive. In these embodiments, they may be mounted to a conductive support. For example, the solid catalyst may include a multi-layer film solid catalyst on a solid catalyst support that is not inherently conductive. The solid catalyst and solid catalyst support can then be mounted onto a conductive support. In one or more embodiments, the solid catalyst may be incorporated into a membrane or film formed from an ion exchange resin polymer. In yet another embodiment, the first liquid catalyst component and the second polymer component are blended and formed into a membrane. One suitable catalyst is disclosed in U.S. application Ser. No. 13/837,372, incorporated by reference below.

Typical catalyst support materials may include conducting carbon blends, wire meshes, metal wires, inorganic oxides, clays and clay minerals, ion-exchanged layered components, diatomaceous earth components, zeolites or a resinous support material, such as a polyolefin, and carbon nanotubes for example. Specific inorganic oxides include silica, alumina, magnesia, titania and zirconia, for example. In one or more embodiments, the support material includes a nanoparticulate material. The term “nanoparticulate material” refers to a material having a particle size smaller than 1,000 nm. Exemplary nanoparticulate materials include, but are not limited to, a plurality of fullerene molecules (i.e., molecules composed entirely of carbon, in the form of a hollow sphere (e.g., buckyballs), ellipsoid or tube (e.g., carbon nanotubes), a plurality of quantum dots (e.g., nanoparticles of a semiconductor material, such as chalcogenides (selenides or sulfides) of metals like cadmium or zinc (CdSe or ZnS, for example), graphite, a plurality of zeolites, or activated carbon. In addition to the non-limiting, exemplary supports listed above, any solid catalyst support known to those skilled in the art may be used depending upon implementation-specific design considerations. Accordingly, other embodiments may employ other supports for the solid catalyst.

Some embodiments may employ an aqueous electrolyte. The aqueous electrolyte may comprise any ionic substance that dissociates in aqueous solution. Exemplary liquid ionic substances include, but are not limited to, Polar Organic Components, such as Glacial Acetic Acid, Alkali or alkaline Earth salts, such as halides, sulfates, sulfites, carbonates, nitrates, or nitrites. In various embodiments, the aqueous electrolyte may be selected from potassium chloride (KCl), potassium bromide (KBr), potassium iodide (KI), hydrogen chloride (HCl), hydrogen bromide (HBr), magnesium sulfate (MgS), sodium chloride (NaCl), sulfuric acid (H₂SO₄), sea salt, brine, or any other suitable electrolyte and acid or base known to the art. Thus, still other electrolytes may become apparent to those skilled in the art having the benefit of this disclosure.

In embodiments employing an electrolyte, the electrolyte may function as a store of excess energy that may be discharged via a fuel cell or some other electrical load. In some of these embodiments, the electrolyte accelerates electrons to exceed the work function of the metal to produce exotic reactions. More particularly, the reactor throws electrons into the electrolyte. So the electrolyte stores the electrons which are in solution by binding them between the cations and anions and so the liquid carries an electric charge. Thus, one can measure a current within the liquid and the current represents an “excess” of electricity. This excess electricity can later be discharged onto a fuel cell or another suitable electrical metal contact.

In electron solvation theory, an electron that exceeds the work function of a metal in its voltage will be ejected off the metal into an electrolyte. This electron will gain energy by increasing its speed due to the interaction between the negatively charged electrons and positive and negative force of the cations and anions. This permits this technique to achieve reactions which are near the theoretical thermodynamic limits. For example, a 0.01V electron can be accelerated 3-5 orders of magnitude. Part of this is how the presently disclosed technique gets the energy to conduct our reactions.

If an electrolyte is used as one reactant, the electrolyte will also be implementation specific depending, at least in part, on the implementation of the catalyst. The electrolyte choice will depend on the reactants desired, as well as the voltages applied. For example, an organic electrolyte, or amine electrolyte would be used for applications which require strong sorbant properties for CO2. In another embodiment, electrolytes such as cuprous chloride might be used for applications which require activation of methane. The catalyst will also effect different reactions. For example, nickel will liberate hydrogen from methane, while copper will form high proportions of methanol and acid than hydrogen as a gas.

The pH of the electrolyte may range from −4 to 14 and concentrations of between 0 M and 3M inclusive may be used. Some embodiments may use water to control pH and concentration, and such water may be industrial grade water, brine, sea water, or even tap water. The liquid ion source, or electrolyte, may comprise essentially any liquid ionic substance.

The presently disclosed technique may be used to react carbon-based gases of a gaseous feedstock in some embodiments. In these embodiments, the gaseous feedstock may comprise a non-polar gas, a carbon oxide, or a mixture of the two with another reactant such as water. Suitable non-polar gases include a hydrocarbon gas. Suitable carbon oxides include carbon monoxide, carbon dioxide, or a mixture of the two. These examples are non-limiting and other non-polar gases and carbon oxides may be used in other embodiments. In some embodiments, the gaseous feedstock comprises one or more greenhouse gases.

The presently disclosed technique may also be used in a reaction cell in which the solid catalyst has been deployed as described above may be used to implement one or more methods for chain modification of hydrocarbons and organic components. The method comprises contacting a gaseous feedstock including a carbon-based gas, an aqueous electrolyte, and the solid catalyst in a reaction area. The carbon-based gas is then activated in an aqueous electrochemical reaction in the reaction area to yield a product. This kind of reaction using a different technique is partially referenced in U.S. application Ser. No. 13/782,936 and U.S. application Ser. No. 13/783,102, both incorporated below.

In one particular embodiment, a process for converting carbon-based gases such as non-polar organic gases and carbon oxides to longer chained organic gases such as liquid hydrocarbons, longer chained gaseous hydrocarbons, branched-chain liquid hydrocarbons, branched-chain gaseous hydrocarbons, as well as chained and branched-chain organic components. In general, the method is for chain modification of hydrocarbons and organic components, including chain lengthening, and eventual conversion into liquids including, but not limited to, hydrocarbons, alcohols, and other organic components.

In one particular embodiment, the technique employs an electrochemical cell. The reaction chamber generally comprises a reactor region in one chamber of which are positioned an electrically active area. In an electrochemical reaction, such an electrically active area is defined by electrodes, which in an electrochemical environment may be termed a cathode and an anode. Here, unlike an electrochemical reaction, the reaction does not use electrodes separated by an electrolyte. Instead, the reaction uses a short circuited metal immersed in an electrolyte. The electrolyte serves to regenerate the catalyst, provide the electron acceleration mechanism, as well as to disperse the electrons throughout the electrolyte so they are able to react with the reactants. The electrolyte thus becomes one of the reactants in this embodiment and the reaction occurs along the current path of the short circuit, rather than in a traditional anode, cathode setup, which creates a potential difference between electrode surfaces.

In addition to the reactor components of this particular embodiment, the electronically active solid catalyst cell includes a first reactant source and a power source, and a second reactant source. In one implementation, a gas source provides the gaseous feedstock while the power source is powering the short circuit along with a current overload circuit in the power supply, which includes the solid catalyst reaction surface, at a selected voltage sufficient to maintain the current flow across the reactant-catalyst interface. The reactant-catalyst interface defines a reaction area. In one example, the reaction pressure might be, for example, 10000 pascals or from 0.01 ATM to 200 ATM, reaction temperatures may be 0.0001 K to 5000 K, and the selected potentials may be, for example, between 0.01 Volts and 1000 Volts.

Those in the art will appreciate that any implementation of a specific embodiment will include details that are omitted or not much discussed herein. For example, various instrumentation such as flow regulators, mass regulators, a pH regulator, and sensors for temperatures and pressures are not shown but will typically be found in most embodiments. Such instrumentation is used in conventional fashion to achieve, monitor, and maintain various operational parameters of the process. Exemplary operational parameters include, but are not limited to, pressures, temperatures, pH, and the like that will become apparent to those skilled in the art. However, this type of detail is omitted from the present disclosure because it is routine and conventional so as not to obscure the subject matter claimed below.

The voltage level can be used to control the resulting product. A voltage of 0.01V may result in a methanol product whereas a 0.5V voltage may result in butanol as well as higher alcohols such as dodecanol. A voltage of 2 volts may results in the production of ethylene or polyvinyl chloride precursors. These specific examples may or may not be reflective of the actual product yield and are meant only to illustrate how a product produced can be altered with a change in voltage. The voltage will also be controlled by a current overload controller, as the wiring is in a short circuit, in order to maintain the system.

The electrochemical cell is a reactor, and can be fabricated from conventional materials using conventional fabrication techniques. Notably, the presently disclosed technique may operate at room temperatures and pressures whereas conventional processes are performed at temperatures and pressures much higher. Design considerations pertaining to temperature and pressure therefore can be relaxed relative to conventional practice. However, conventional reactor designs modified to include the teachings herein may nevertheless be used in some embodiments.

In general, the short circuit electrical activation of the catalyst means that there is no electrode interference as is found in conventional electrochemical systems. General operating parameters for various embodiments are temperatures of 0 K to 1800 K, pressures 0 to 1000 ATM, and voltages should be 0 to 5 V. Some embodiments may be able to operate at voltages as low as 0.1 to 3.0 V.

This is a function of the electrical short circuit mechanism. The short circuit actually drives a current through the catalyst rather than inducing one through application of an electromagnetic field, the presently disclosed technique produces a measurable current flowing backwards with no current flows in portions of our shorted circuit reactor. Thus, it is quite a different species than a current than is found in conventional approaches.

Furthermore, when there is a short circuit, a large number of unknown, chaotic magnetic effects occur. The magnetic field is deformed due to winding distributions to slots and due to short circuit current. Some of the magnetic flux lines are closing through the poles and magnetic circuit of generator and the other flux lines are closed through the air, but their closing ways are not the same as the load and no load conditions. There are bigger flux line densities. However, results from the presently disclose technique show that it breaks electric bonds at much lower energies than normal, which is a significant difference from conventional approaches that only run a current through the catalyst.

Illustrative embodiments of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The presently disclosed technique provides a way to electrically activate a solid catalyst, allowing it to facilitate reactions which do not occur at temperatures, pressures, and electrical voltages (potentials) without the aid of such activation. The technique employs a reactor such as the reactor 100 in FIG. 1 in a system such as the system 200 in FIG. 2. The system 200 includes not only the reactor 100, but also an accumulator 203 and a cold trap 206. It also includes a couple of pumps or compressors 209 to provide motive force to fluids circulating in the system 200. Those in the art having the benefit of this disclosure will appreciate that the system 200 is simplified for purposes of illustration. The system 200 admits wide variation in implementation beyond what is shown in the drawings. In particular, the system 200 may readily be scaled in size, complexity, and sophistication. The manner in which this may be done will be readily apparent to those skilled in the art once they have had the benefit of this disclosure.

Selected details of the reactor 100, accumulator 203, and cold trap 206 will now be discussed. Some detail shown in the drawings will be omitted for the sake of clarity and so as not to obscure the invention. For example, certain fittings associated with the reactor 100, accumulator 203, and cold trap 206 are shown but will not be discussed in any detail because they are commonly used by and well known to those in the art. For another example, the operation and implementation of the pumps/compressors 209 will also be omitted for the same reason.

Turning now to FIG. 3A-FIG. 3C, the reactor 100 of FIG. 1 is shown in greater detail for one particular embodiment. FIGS. 3A-3C are side, top, and bottom plan views, respectively, of the reactor 100. In particular, the reactor 100 includes a pipe 300 made of metal and concentrically disposed within a cylindrical heater 303. It also includes an egress 306 for reacted product as well as ingresses 309, 312 for reactants—a gas feedstock and a liquid feedstock, respectively, in this particular embodiment. A sparger 321, or air stone, is also included on the ingress 309 that causes the gas feedstock to bubble up through the liquid during operation.

Disposed within the pipe 300 are a plurality of solid catalyst plates 315 (only one indicated). The solid catalyst plates 315 are stacked so that they contact one another. They comprise a copper mesh affixed to a circular copper frame, neither of which is separately shown. A pair of electrical connections 318 receive power from an external supply not shown and are electrically connected to a solid catalyst plate 315. In operation, power is provided to the electrical connections 318 and, since copper is electrically conductive, short circuit through the electrically conductive plates 315.

In most cases, the forces due to short-circuits are applied very suddenly. Direct currents give rise to unidirectional forces while alternating currents produce vibrational forces. These short-circuit forces have to be absorbed first by the conductor through which the short circuit occurs. The conductor therefore should have an adequate proof strength to carry these forces without permanent distortion. Copper satisfies this requirement as it has high strength compared with some other conductor materials.

Those in the art having the benefit of this disclosure will appreciate that the identity, configuration, and disposition of the various components will be implementation specific details. For example, if pipe 300 is plastic, then the heater 303 will be disposed with the pipe 300 and the solid catalyst plates 315 within the heater 303. Furthermore, the solid catalyst plates 315 may be realized using other materials and other structures appropriate for those materials as discussed above. Note also that some embodiments may use a solid catalyst that is not electrically conductive and so may use an electrically conductive catalyst support as described above. These and other such variations are all within the scope of the presently disclosed technique.

The reactor 100 defines a reaction volume 330. In this particular embodiment, the reaction volume 330 is closed. However, alternative embodiments may use an open reaction volume. An open reactor is the same as the closed reactor except with the top end is open to the environment while liquid is circulated out separately, or run in a scrubber fashion and introduced from the top of the reactor. Similarly, in the illustrated embodiment, the catalyst (i.e., the solid catalyst plates 315) is surrounded by the reaction volume 330 but in some embodiments the catalyst may surround the reaction volume. For example, the catalyst may be cylindrically shaped, or supported on a cylindrically shaped support, and disposed within the reactor 100 so that they it lines the interior wall thereof.

The accumulator 302 first shown in FIG. 2 is shown in greater detail in FIG. 4A-FIG. 4D. FIGS. 4A-4D are opposing side, top, and bottom plan views, respectively, of the accumulator 203. The accumulator 203 includes some implementation specific features such as a float-type sensor level 400, a pressure sensor 403, a thermocouple 406, and a pressure relief valve 409. It also includes an ingress 412 for a water resupply, an egress 413 to the cold trap 206, an ingress 415 from the reactor 100, an egress 428 to the reactor 100, and a plurality of heating rods 421.

The cold trap 206, first shown in FIG. 2, is shown in greater detail in FIG. 5A-FIG. 5D, which are opposing side, top, and bottom plan views, respectively, of the cold trap 206. The cold trap 206 includes an egress 500 and an ingress 503 to and from, respectively, a chiller (not shown) that circulates a coolant through the coil 506 in a manner described more fully below. It also includes a level sensor 509 and a thermocouple 512 that are implementation specific. Finally, it also includes an egress 515 and an ingress 518 to and from the reactor 100.

FIG. 6 is a schematic of one particular implementation 600 of the system in FIG. 2. This schematic contains implementation specific details omitted from FIG. 2. For example, several flow meters 603, additional pressures sensors 606, a thermocouple 609, a pH sensor 612, a check valve 615, and flow control valves 618. The system 600 also includes a chiller 621 operating in conjunction with the cold trap 206 as mentioned above.

FIG. 6 shows the system in operation. The accumulator 203 receives the gas and liquid feedstocks 624, 627 from fresh supplies not otherwise shown. The gas and liquid feedstocks 624, 627 are reactants and are, in this particular embodiment, carbon dioxide (CO₂) and fresh water. Some embodiments may employ two gas feedstocks. Gas-gas feedstocks such as steam and Methane or CO2 may be used to effect a water gas shift reaction. Some embodiments may also employ carbon monoxide (CO) and Hydrogen (H) to catalyze Fischer Tropsche reactions. Other embodiments may employ two liquid feedstocks. For liquid-liquid reactions, two liquid reactants may be introduced into the reactor to produce a new product.

Note that the identity of the feedstocks is implementation specific and may vary as described above. Also as described above, some embodiments may employ two gas feedstocks or two liquid feedstocks rather than one gas and one liquid. Similarly, the number of feedstocks may vary by implementation and contain more or fewer feedstocks than the two shown. The accumulator 203 also receives a gaseous product from the reactor 100 over the line 630.

Accordingly, during operation, the accumulator 203 contains a mix of gas and liquid comprised of gaseous feedstock, liquid feedstock, and gaseous product. A heater 633, which includes the heating rods 421 shown in FIG. 4A-FIG. 4C, heats this mixture to the boiling point of the product. The gaseous mixture of the accumulator 203, comprised primarily of product and gas feedstock 624, is then output from the top of the accumulator 203 to the cold trap 206 over the line 636. The liquid mixture in the accumulator 203, comprised primarily of the liquid reactant 627, is then output from the bottom of the accumulator 203 to the reactor 100 over the line 639.

The cold trap 206 receives not only the gaseous mixture from the accumulator 203, but also receives a fresh supply of gaseous feedstock 624. This is an optional feature that may be omitted. Similarly, the fresh supply to the cold trap 206 may be from a different source than that to the accumulator 203. The cold trap 206 includes another liquid/gas mixture, the liquid coming from the chiller 624. The chiller 624 draws off the liquid/gas mixture and cools it to condense more the gas to liquid. The liquid can be drawn off to obtain the product yield 642 for the process. Some of the gas from the mixture, which may be a combination of gaseous product and gas feedstock 624, is then cycled back to the reactor 100 over the line 645.

So, in addition to the liquid mixture received over the line 639, the reactor 100 also receives a gaseous product/gas feedstock mixture from the cold trap 206 over the line 645. The content of the reactor 100 therefore is primarily liquid feedstock 627 (in the liquid mixture from the accumulator 203) and gas feedstock 624 (from the cold trap 206) with some gaseous product (from the cold trap 624). The gaseous component from the cold trap 206 bubbles up into the reactor 100 through the sparger 321.

As mentioned above, the solid catalyst plates 315 (only one indicate, and all conceptually illustrated) receive electrical power from an electrical source 648. In this case, it is an alternating current source, but it could be a direct current source in alternative embodiments. The nature of the electrical power signal output from the electrical source 648 may therefore vary widely across implementations. Other operational characteristics such as current and voltage will be implementation specific in a manner that those having the benefit of this disclosure will be able to readily implement.

The solid catalyst plates 315 are copper and so are electrically conductive. They are short circuited through their contact with one another. This electrically activates the copper as the catalyst for the reaction with the gas feedstock and the liquid feedstock. The reaction proceeds apace as described above and gaseous product is returned to the accumulator 203 over the line 530, also as described above.

The product yield 642 may be used in a variety of ways depending chiefly on what it is. Those in the art having the benefit of this disclosure will appreciate that the choice of feedstocks will influence what the yield is. Similarly, the solid catalyst should be chosen in that light as well to facilitate the reaction.

For example, consider the application for the presently disclosed technique shown in FIG. 7. This particular embodiment is used for emissions mitigation and providing hybrid power to a vehicle not otherwise shown. Products from the unit are high octane hydrocarbon gases which may be fed back into the engine to boost the efficiency, or a stable aqueous solution of simple organic chemicals such as formic acid, which may later be processed or dumped as liquid waste. The engine 700 may be conventionally powered with gasoline, diesel fuel, or some other petroleum based fuel and a liquid and/or gas product from the system 705. The conventional gasoline powered side of the system 705 is not shown, nor are the various components dedicated to the switchover from gasoline to yield product.

The system 705 includes a reactor 100 and an accumulator 203 structured and operated as described above. The liquid feedstock is water from a water supply 624′ and the gas feedstock is the exhaust from the engine 700. Particulates are filtered from the exhaust by a conventional filter 710 prior to introduction into the reactor 100. Electrical power to the solid catalyst plates 315 of the reactor 100 is provided by the vehicle's battery 645′.

Since the gas feedstock in this embodiment is the engine exhaust, engine ignition is handled by the gasoline powered side (not shown) of the system 705. All liquid products get dumped into the accumulator 203 and is recirculated as a reactant. When there is spare electricity, the voltage is increased, and the products are gases such as ethylene, which boost the octane rating and efficiency of the engine. This product is fed directly back into the engine for recombustion. The system 705 therefore mitigates the exhaust emissions by recycling the exhaust back the reactor 100 to react it with the water and yield a product that is benign to the environment. In some embodiments (not shown), the product yield is a gas that can then be used to help power the vehicle directly or used to charge batteries that can then provide electrical power to run the vehicle.

The engine 700 of FIG. 7 is a combustion engine, and may be of the kind found in, for example, vehicles of various types. This particular embodiment may therefore be adapted for use with automobile engines, diesel truck engines, ship engines, diesel engines, natural gas turbines, diesel generators, boilers, and heaters. However, this list is by way of example and illustration is not to be considered as limiting of the applications to which this particular embodiment may be employed.

This particular embodiment may also be adapted for use in noxious gas mitigation in a variety of contexts. For example, such a system may be attached to a point source gas emitter that includes a flue gas exhaust that provides a reactant feedstock. Such point source gas emitters may include power plants, industrial emitters, vented natural gas, flared natural gas, CO₂ reservoirs, large commercial emitters, landfills, farms, and offshore oil and gas platforms. Again, this list is by way of example and illustration is not to be considered as limiting of the applications to which this particular embodiment may be employed.

Still other embodiments can be realized. In one alternative embodiment the reactor 100 is an electrified slurry reactor wherein a slurry of particles acts as the reactant and is passed through the reaction volume. By pumping the catalyst slurry through a mesh in the reactor volume, the individual particles are also charged and activated. So the slurry acts as an additional catalyst circulating through the reactor volume. The products may be the same as what is discussed above. However the rates would be different as well as the product distribution. The rates would be much higher due to the increased reaction area available.

Another embodiment produces fine chemicals such as rocket fuels and pharmaceutical precursors. As will be recognized by those skilled in the art, fine chemicals are used as starting materials for specialty chemicals, particularly pharmaceuticals, biopharmaceuticals and agrochemicals. They are complex, single, pure chemical substances, produced in limited quantities in multipurpose plants by multistep batch chemical or biotechnological processes. They are used for further processing within the chemical industry. The class of fine chemicals is subdivided either on the basis of the added value (building blocks, advanced intermediates or active ingredients), or the type of business transaction, namely standard or exclusive products. The term “fine chemicals” is used in the art in distinction to “heavy chemicals”, which are produced and handled in large lots and are often in a crude state.

Some particular embodiments may process crude oils, heavy oils, and tar sands to sweeten crude oil and heavy fraction hydrocarbons to lower chained hydrocarbons or to crack heavy hydrocarbons into lighter hydrocarbon liquids and gases. These types of reactants and reactions are suitable for use in a slurry embodiment of the reactor provided the catalyst and/or catalyst support do not include a mesh of some kind. Suitable catalysts for this type of embodiment include transition metals such as Copper, Nickel, and Cobalt. Zeolites and other catalysts known in the art for petrochemical processing may also be used. Semiconducting materials on a conducting support may also be used.

Some embodiments may process biofuels. Examples of such embodiments would include breaking of algae into constituent components, processing of biogases into liquids, processing biofuels into higher grade chemicals, and processing of raw biomaterial into liquids through first combusting the biomaterial into the reactor. This last application would include first combusting the biomaterial and then directly ingesting the combusted biomaterial as a solid slurry. For example, one may break algae cell walls and then extrude the fatty acids portions to make them available for production of fuels. Examples of suitable catalysts for these types of embodiments include transition metals such as Copper, Nickel, Cobalt.

One particular embodiment regenerates spent catalysts for reuse in the system or other systems of similar design. For example, cobalt catalysts, iron oxide catalysts, and platinum catalysts which have been fouled during a reaction by solids and sludge, may be fed through the reactor under 1V-2V which is sufficient to cause the solid carbons to oxidize into carbon dioxide. The process will also remove any oxidants which might have formed on the surface of the particles by filling the oxidation compounds will electrons from the reactor.

Some embodiments may include more than one system such as the system of FIG. 6, each organized into discrete units within a still larger system. The units may be cascaded to operate in series or they may operate in parallel. In embodiments wherein multiple units are cascaded, the yield product of one unit may be used as a reactant or an electrolyte in a succeeding unit in the cascade.

### EXAMPLES

A copper tube is packed with a braided copper wire and copper particles. Carbon Dioxide and Water vapor are fed into the wire, which is configured in a short circuit, which is then powered. The products as determined by a GC/MS were a mixture of c2-c8 hydrocarbons and oxygenates.

Note that not all embodiments will manifest all these characteristics and, to the extent they do, they will not necessarily manifest them to the same extent. Thus, some embodiments may omit one or more of these characteristics entirely. Furthermore, some embodiments may exhibit other characteristics in addition to, or in lieu of, those described herein.

The phrase “capable of” as used herein is a recognition of the fact that some functions described for the various parts of the disclosed apparatus are performed only when the apparatus is powered and/or in operation. Those in the art having the benefit of this disclosure will appreciate that the embodiments illustrated herein include a number of electronic or electro-mechanical parts that, to operate, require electrical power. Even when provided with power, some functions described herein only occur when in operation. Thus, at times, some embodiments of the apparatus of the invention are “capable of” performing the recited functions even when they are not actually performing them—i.e., when there is no power or when they are powered but not in operation.

The following patent, applications, and publications are hereby incorporated by reference for all purposes as if set forth verbatim herein:

U.S. application Ser. No. 13/837,372, entitled, “Method and Apparatus for a Photocatalytic and Electrocatalytic Copolymer”, filed Mar. 15, 2013, in the name of the inventors Tara Cronin and Ed Chen and commonly assigned herewith.

U.S. application Ser. No. 13/783,102, entitled, “Method and Apparatus for an Electrolytic Cell Including a Three-Phase Interface to React Carbon-Based Gases in an Aqueous Electrolyte”, filed Mar. 1, 2013, in the name of the inventor Ed Chen and commonly assigned herewith.

International Application Serial No. US13/783,102, entitled, “Chain Modification of Gaseous Methane Using Aqueous Electrochemical Activation at a Three-Phase Interface”, filed Mar. 1, 2013, in the name of the inventor Ed Chen and commonly assigned herewith.

International Application Serial No. PCT/US13/28748, entitled, “Method and Apparatus for an Electrolytic Cell Including a Three-Phase Interface to React Carbon-Based Gases in an Aqueous Electrolyte”, filed Mar. 1, 2013, in the name of the inventor Ed Chen and commonly assigned herewith.

International Application Serial No. PCT/US13/28728, entitled, “Chain Modification of Gaseous Methane Using Aqueous Electrochemical Activation at a Three-Phase Interface”, filed Mar. 1, 2013, in the name of the inventor Ed Chen and commonly assigned herewith.

To the extent that any patent, patent application, or other reference incorporated herein by reference conflicts with the present disclosure set forth herein, the present disclosure controls.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A reaction chamber comprising:
a catalyst that, in use, is wired to a power source in electrical short circuit configuration with a current limiting circuit in the power supply; and
a reaction volume in which the catalyst is disposed and wherein reactants are introduced while a current is introduced across the short circuited catalyst.

2. The reaction chamber of claim 1, wherein the catalyst is a solid catalyst.

3. The reaction chamber of claim 1, wherein the catalyst is affixed to a non-insulating catalyst support.

4. The reaction chamber of claim 3, wherein the non-insulating catalyst support is an electrically conductive catalyst support.

5. The reaction chamber of claim 3, wherein the non-insulating catalyst support is an electrically semi-conductive catalyst support.

6. The reaction chamber of claim 1, wherein the electrical short-circuit configuration is a direct current electrical short-circuit configuration.

7. The reaction chamber of claim 1, wherein the electrical short-circuit configuration is an alternating current electrical short-circuit configuration.

9. The reaction chamber of claim 1, wherein the reaction volume surrounds the solid catalyst.

10. The reaction chamber of claim 1, wherein the reaction volume is surrounded by the solid catalyst.

11. The reaction chamber of claim 1, further comprising the power source.

12. The reaction chamber of claim 1, wherein the power source outputs a pulse or a waveform, or other configuration of electrical signals.

13. The reaction chamber of claim 1, wherein the reaction volume is a closed reaction volume.

14. The reaction chamber of claim 1, wherein the reaction volume is an open reaction volume.

15. The reaction chamber of claim 1, further comprising a heating element within the reaction volume.

16. A system, comprising:
a plurality of reactant feedstocks;
a power supply;
a reactor, comprising:
a catalyst that, in use, is wired to the power source in electrical short circuit configuration;
a reaction volume in which the catalyst is disposed and wherein the reactant feedstocks are introduced while a current is introduced across the short circuited catalyst to react the reactant feedstocks and yield a product; and
a collector for the product yielded by the reaction.

17. The system of claim 16, wherein:
the system is an electrified slurry reactor, and
one of the reactant feedstocks is a slurry of particles.

18. The system of claim 16, comprising:
a second plurality of reactant feedstocks;
a second reactor, comprising:
a second catalyst that, in use, is wired to the power source in electrical short circuit configuration;
a second reaction volume in which the catalyst is disposed and wherein the second reactant feedstocks are introduced while a current is introduced across the short circuited second catalyst to react the second reactant feedstocks and yield a second product; and
a second collector for the second product yielded by the second reaction.

19. The system of claim 18, wherein the second catalyst differs from the first catalyst.

20. The system of claim 19, wherein the second product differs from the first product.

21. The system of claim 18, wherein the second product differs from the first product.

22. The system of claim 16, further comprising, in operation, an electrolyte disposed within the reaction volume.

23. The system of claim 22, wherein the electrolyte performs as an additional current conductor and store of energy.

24. The system of claim 22, wherein one of the reactant feedstocks is a gas that, in operation, reacts with the electrolyte and is converted to a liquid yield product by the reaction.

25. The system of claim 22, wherein the electrolyte accelerates electrons that exceed the work function of the metal to product exotic reactions.

26. The system of claim 16, further comprising a point source gas emitter including a flue gas exhaust that provides a reactant feedstock.

27. The system of claim 16, further comprising a combustion engine including an exhaust that provides a reactant feedstock.

28. The system of claim 27, further comprising a recycle of the yield product to the combustion engine.

29. The system of claim 16, wherein the yield product is ammonia.

30. The system of claim 16, wherein the yield product is a fine chemical.

31. The system of claim 16, wherein the reactant feedstocks include crude oils, heavy oils, or tar sands.

32. The system of claim 16, wherein the reactant feedstocks include algae and the yield product includes constituent components of the algae.

33. The system of claim 16, wherein the reactant feedstocks include biogases and the yield product includes liquids.

34. The system of claim 16, wherein the reactant feedstocks include biofuels and the yield product includes higher value chemicals.

35. The system of claim 16, wherein the reactant feedstocks include combusted biomaterial and the yield product includes liquids.

36. The system of claim 16, further comprising a cold trap.

37. The system of claim 36, further comprising an accumulator.

38. The system of claim 16, further comprising an accumulator.

39. A method, comprising:
providing a plurality of reactant feedstocks to a reaction volume within a reactor;
electrically activating a short-circuited catalyst disposed within the reaction volume of the reactor;
reacting the reactant feedstocks in the presence of the electrically activated catalyst; and
collecting the yield product of the reactions.

40. The method of claim 39, further comprising affixing the catalyst to a non-insulative catalyst support.

41. The system of claim 39, wherein:
the reactor is an electrified slurry reactor; and
one of the reactant feedstocks is a slurry of particles.

42. The system of claim 39, comprising:
providing a second plurality of reactant feedstocks to a second reaction volume within a second reactor;
electrically activating a second short-circuited catalyst disposed within the second reaction volume of the second reactor;
reacting the second reactant feedstocks in the presence of the electrically activated second catalyst; and
collecting the second yield product of the second reactions.

43. The method of claim 42, wherein the second catalyst differs from the first catalyst.

44. The method of claim 19, wherein the second product differs from the first product.

45. The method of claim 42, wherein the second product differs from the first product.

46. The method of claim 39, further comprising disposing an electrolyte within the reaction volume.

47. The method of claim 46, wherein the electrolyte performs as an additional current conductor and store of energy.

48. The method of claim 46, wherein one of the reactant feedstocks is a gas that, in operation, reacts with the electrolyte and is converted to a liquid yield product by the reaction.

49. The method of claim 46, wherein the electrolyte accelerates electrons that exceed the work function of the metal to product exotic reactions.

50. The method of claim 39, wherein providing a plurality of reactants includes providing a flue gas exhaust from a point source gas emitter.

51. The method of claim 39, wherein providing a plurality of reactants includes providing an exhaust of combustion engine as a reactant feedstock.

52. The method of claim 51, further comprising a recycle of the yield product to the combustion engine.

53. The method of claim 39, wherein the yield product is ammonia.

54. The method of claim 39, wherein the yield product is a fine chemical.

55. The method of claim 39, wherein the reactant feedstocks include crude oils, heavy oils, or tar sands.

56. The method of claim 39, wherein the reactant feedstocks include algae and the yield product includes constituent components of the algae.

57. The method of claim 39, wherein the reactant feedstocks include biogases and the yield product includes liquids.

58. The method of claim 39, wherein the reactant feedstocks include biofuels and the yield product includes higher value chemicals.

59. The method of claim 39, wherein the reactant feedstocks include combusted biomaterial and the yield product includes liquids.

60. The method of claim 39, further comprising condensing the yield product in a cold trap prior to collection.

61. The method of claim 60, further comprising accumulating reactants and product yield and recycling them back into the reaction.

62. The method of claim 39, further comprising accumulating reactants and product yield and recycling them back into the reaction.
